(19) United States
(12) Patent Application Publication
(10) Pub. No.: US 2007/0282983 A1
(43) Pub. Date: Dec. 6, 2007

(54) System and Method for Information Handling System Management With a Directory Service Tool Box

(76) Inventors: Manoj Gujarathi, Round Rock, TX (US); Charles T. Perusse, Pflugerville, TX (US); Jimmy D. Pike, Georgetown, TX (US); Drue Reeves, Round Rock, TX (US)

Correspondence Address: HAMILTON & TERRILE, LLP, P.O. BOX 203518, AUSTIN, TX, 78720, US

(21) Appl. No.: 11/422,153

(22) Filed: Jun. 5, 2006

(51) Int. Cl. G06F 17/30; G06F 15/173; G06F 12/00; G06F 7/00

(52) U.S. Cl. 709/223; 707/200; 707/10

(57) ABSTRACT

A directory service architecture simplifies management of operations of plural server information handling systems. A server object associated with each server information handling system applies an associated server policy to perform tasks of a task list at the associated server information handling system. The tasks call tool box objects from a tool box, the tool box objects having tool distinguished names that point to tool objects. The tool objects have tools that deploy to the server information handling system to perform the tasks of the task lists, such as updating applications, running diagnostics, running virus scans or otherwise executing applications at the server information handling system. A policy class set up to do a task with a tool object for a server object is applied to other server objects by copying the service to the other server object policies.

### BACKGROUND OF THE INVENTION

1. Field of the Invention

The present invention relates in general to the field of information handling system operational management, and more particularly to a system and method for information handling system operations management with a directory service tool box.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have greatly improved the productivity of enterprise employees. Much of the productivity gains have centered about the networking of information handling systems. Networking provides enterprise employees with convenient and secure communications, such as by e-mail, and ready access to enterprise information, such as through information handling system configured as servers. Large enterprises with hundreds or even thousands of employees often establish and maintain large and complex data centers that have numerous servers. These data centers are often the central nervous system of the enterprise, tracking information that manages enterprise resources, scheduling enterprise events and coordinating enterprise activities. Enterprise employee access to data center servers is typically managed by applications running on the servers, such as a directory service. A directory service stores and organizes information about network users and shares and act as an abstraction layer between users and shared resources. A directory service maps the names of network resources to network addresses with each resource considered an object in the directory service, the object having information particular to a resource stored as attributes of the object. A name space, such as LDAP's distinguished names, provides a set of rules that refer to a collection of attributes that make up a directory entry. Directory services typically use a hierarchical organization.

One difficulty with establishing and maintaining a data center is loading and maintaining the applications that run on the various server information handling systems. Generally, software and hardware changes and updates within an enterprise data center are manually performed on a server-by-server basis. Manual updates are time-consuming, complex and subject to individual operator errors. Manual updates limit the cost-effectiveness of scaling a data center to grow with an enterprise's information handling needs since adding equipment is labor intensive. Manual updates also increase the complexity and expense of maintaining an existing data center since all “tools,” meaning mandatory compliance software and updates as well as system specific or optional applications, are manually customized for each server. Ignoring such updates is not typically a viable option where the enterprise seeks to maintain security of its information. Often, enterprises have a number of information technology specialists whose duties focus entirely on managing applications on the enterprise's data center servers.

### SUMMARY OF THE INVENTION

Therefore a need has arisen for a system and method which provides a centralized tool box policy driven directory structure to host enterprise tools by monitoring and pushing down applicable tools for establishing and maintaining a desired server configuration state.

In accordance with the present invention, a system and method are provided which substantially reduce the disadvantages and problems associated with previous methods and systems for establishing and maintaining software configurations of server information handling systems. A directory service architecture simplifies management of operations of plural server information handling systems by relating application images, tool objects and tool box objects with a schema and extending the schema to server objects through policies specifying tasks using distinguished names to point to tool box objects and tools.

More specifically, plural server information handling systems are each managed by associated server objects. The server object applies an associated server policy to manage server operations. The server policy has a task list with one or more tasks and one or more tool box objects associated with tools used to accomplish tasks of the task list. The tool box objects are, for instance, distinguished name pointers associated with a tool box that contains plural tool box objects associated with management of the server information handling systems. The tool box objects point to tool objects having an associated tool for performing a task or tasks of the server object task list. The tools are deployed to server information handling systems according to the policies of the server object associated with each server information handling systems. Tasks performed by the deployment of tools are scheduled by a task scheduler that manages the task list of each server object policy. A class set up to do a task with a tool box object in a server object policy is copied to other server object policies to provide the same service to other servers. Examples of tasks include deployment of enterprise applications, deployment of application updates such as operating system patches, execution of diagnostics at a server information handling system or execution of a virus scan at a server information handling system.

The present invention provides a number of important technical advantages. One example of an important technical advantage is that facility-level cost effective scaling is provided by seamlessly bringing added information handling system servers to a standardized software environment, with additions either planned or made on the fly. Facility-level policy based software application pushes are provided to target servers without user intervention as defined by server object policies. Centralized and secure software application management and maintenance are provided on a common directory service through the grouping of tool boxes, tools and images to create a software image hierarchy based on the type of software or through other custom grouping applicable to specific enterprise environments. Hardware drivers or other software content are available without separate media, and an extension to create policies supports update roll-back to well-known, valid states.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a directory service architecture for managing plural server information handling systems; and

FIG. 2 depicts a flow diagram of a process for deploying tools in a directory service architecture that manages operations of server information handling systems.

### DETAILED DESCRIPTION

Management of server information handling system operations through a directory service schema simplifies the deployment of tools to perform management functions. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

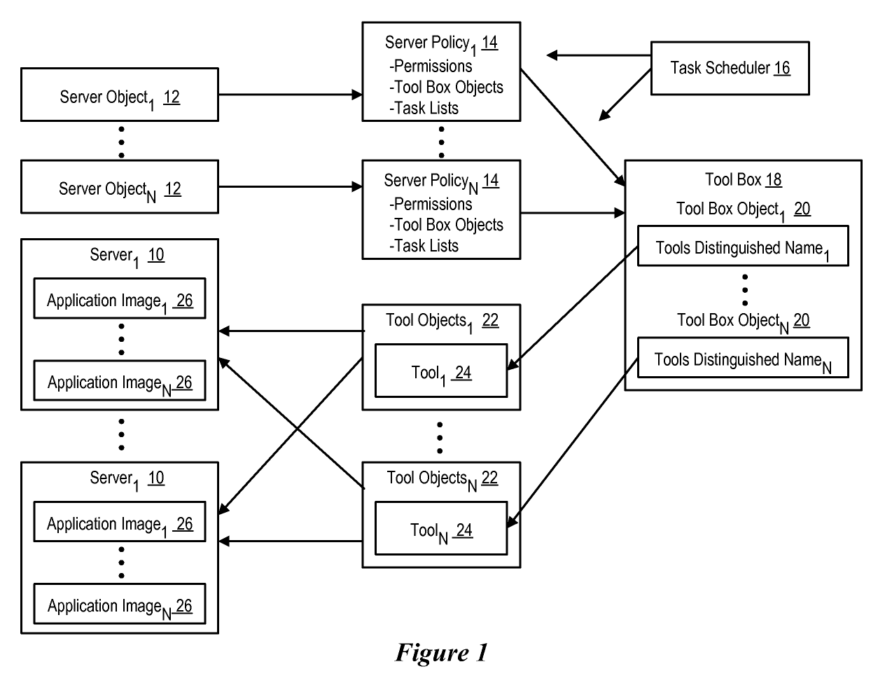

Referring now to FIG. 1, a block diagram depicts a directory service architecture for managing plural server information handling systems 10. The directory service infrastructure manages deployment of system compliant applications, such as virus protection or diagnostic applications, as well as enterprise specific or optional applications, such as to manage sales. A server object 12 associated with each server 10 manages operations of its associated server 10 according to an associated server policy 14. Each server policy 14 includes permissions, tool box objects and task lists use in management of the associated server 10. For example, a task scheduler 16 supports the generation of tasks for the task list in server policy 14 to accomplish desired management operations at predetermined times. The management operations involve the deployment of one or more tools to the associated server 10 from a tool box 18. For instance, a task might include the running of a virus scan at a scheduled time, the running of diagnostics for a server 10 having difficulties, the updating of applications on a server 10, such as an operating system patch, or the deployment of an enterprise application to run on a server 10. Once task scheduler 16 has set up a class in a server policy 14 to accomplish a desired task, the same task is scheduled at other servers 10 by copying the service from the existing server policy 14 to the server policies 14 associated with servers 10 at which the task is desired.

Tool box 18 provides a centralized location to which server objects 12 point to accomplish tasks. Tool box 18 includes plural tool box objects 20 which each tool box object 20 pointing to a tool object 22 having a tool 24. For instance, tool box objects 20 are directory service distinguished names used to call associated tools 24. Thus, server objects 12 point to unique tool box objects 20 which, in turn, point to unique tools 24 through distinguished name pointers. Each tool 24 points to an application image 26 to be pushed down to the server 10 associated with the server object 12. This directory service object and policy schema creates a hierarchy of tool box and tool objects using distinguished name pointers having an extensibility to map different objects and policies to invoke meta-directory services, such as for triggering enterprise-wide functions like diagnostics and software updates. A scalable map through unique objects in the directory service infrastructure can be extended to create customized groupings and deploying of solutions. Tools and application images may be distributed throughout servers 10 with the centralized tool box 18 providing coordination of tasks by distributed components, improved security and logical groupings. As new servers 10 are brought into service, the configuration of the new server may be established by copying a server object 12 and server policy 14 having a standardized configuration to rapidly and seamlessly bring the new server 10 to an operational state. Applications receive a facilities policy push to the new server without user intervention based upon defined server object policies. Further, in the event of difficulties in a policy push of an application, reassertion of previous or known safe policy provides a roll-back ability to a known valid server configuration state.

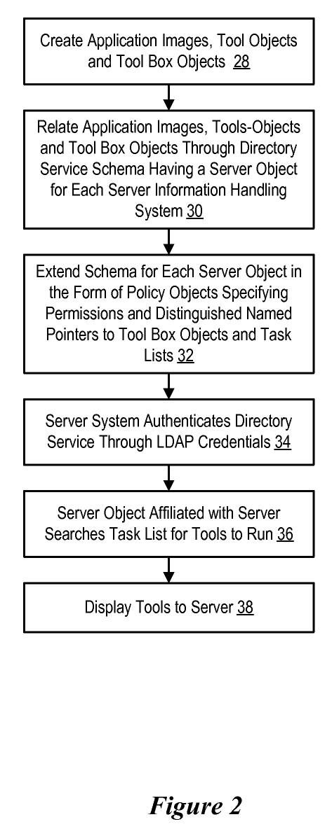

Referring now to FIG. 2, a flow diagram depicts a process for deploying tools in a directory service architecture that manages operations of server information handling systems. The process begins at step 28 with the creation of application images, tool objects and tool box objects on one or more of the server information handling systems. At step 30, the application images, tool objects and tool box objects are related through a directory service schema having a server object for each server information handling system. As an example, a driver tool includes all drivers for hardware components on the managed server information handling systems. Each server object that seeks to apply a driver is related to the driver tool through a tool box object having the driver tools distinguished name pointer. Upon execution of a task to load a driver at a server information handling system, the distinguished name points to the driver tool through a driver tool object so that the driver tool applies the desired driver to the server information handling system associated with the server object that initiated the task. Other tasks, such as virus scans, diagnostics or deployment of enterprise applications, may be accomplished in a similar way.

At step 32, the directory service schema is extended for server objects in the form of policy objects that specify permissions and distinguished name pointers to tool box objects and task lists. The policy object is, for example, an auxiliary or derived class of the server object. The policy object establishes the tasks desired at an associated server and allows scheduling of the tasks at desired times. Different tool boxes may be organized according to functions, such as a tool box for system compliant functions like virus protection and operating system updates and a tool box for enterprise applications. To perform a policy based task, the server at step 34 authenticates the directory service, such as through LDAP credentials, and at step 36 the server object searches the task list for the tools to run the task. The tools are tracked in the task list with tool box objects that point to the appropriate tool box. The tools are deployed to the server through a policy based push or, if the server authenticates the directory, through a autonomical pull. Based on the directory server mapping structure, meta directory server or other services interacting with the directory service can subscribe to server policy objects with implicit asks for groups of tools. Alternatively, a directory service can subscribe to server policy objects to invoke a predetermined task listed in a task list, such as to perform enterprise facility based applications, like diagnostics or software updates.

Although the present invention has been described in detail, it should be understood that various changes, substitutions and alterations can be made hereto without departing from the spirit and scope of the invention as defined by the appended claims.

What is claimed is:

1. A directory service system for managing plural server information handling systems, the directory service system comprising:
plural tool objects, each tool object associated with one or more tools, each tool associated with one or more application images;
a tool box having plural tool box objects, each tool box object having a tool distinguished names, each distinguished name pointing to a tool object;
a server policy associated with each server information handling system, the server policy defining one or more tasks for an associated server information handling system, the tasks applying one or more tool box objects; and
a server object associated with each server information handling system, the server object operable to apply the server policy associated with the server information handling system to perform the server policy tasks.

2. The directory service system of claim 1 further comprising a task scheduler operable to define tasks for each server policy.

3. The directory service system of claim 2 wherein the task scheduler defines tasks for a server policy by copying an existing task from an existing server policy.

4. The directory service system of claim 1 wherein the tasks comprise a diagnostic application operable to diagnose a server information handling system.

5. The directory service system of claim 1 wherein the tasks comprise an application update to an application on one or more server information handling systems.

6. The directory service system of claim 5 wherein the application update comprises an operating system patch.

7. The directory service system of claim 1 wherein the tasks comprise a virus scan at a server information handling system.

8. The directory service system of claim 1 wherein a tool comprises plural drivers, each driver associated with a hardware component on one or more server information handling systems, each server object operable to apply one or more drivers to an associated server information handling system.

9. The directory service system of claim 1 wherein the server object applies the server policy by pushing a tool associated with a task to the associated server information handling system.

10. The directory service system of claim 1 wherein the server object applies the server policy by directing the associated server information handling system to pull the tool associated with a task.

11. A method for managing plural server information handling systems with plural tools, the method comprising:
creating application images, tool objects and tool box objects on one or more of the server information handling systems;
relating the application images, tool objects and tool box objects through a directory service schema having a server object for each server information handling system;
extending the directory service schema with a policy object for each server object, each policy object specifying a task list having one or more tasks and one or more tool box objects associated with each task; and
executing the task lists with the server objects by deploying the tool box objects.

12. The method of claim 11 wherein the tool box objects comprise distinguished name pointers to tool box objects for deploying associated tools.

13. The method of claim 11 wherein executing the task lists comprises deploying a virus scan to the server information handling system associated with the task list server object.

14. The method of claim 11 wherein executing the task list comprises deploying a driver to the server information handling system associated with the task list server object.

15. The method of claim 11 wherein executing the task list comprises deploying an application update to the server information handling system associated with the task list server object.

16. The method of claim 15 wherein the application update comprises an operating system patch.

17. The method of claim 11 wherein executing the task lists with the server objects by deploying the tool box objects further comprises pushing the tool to the server information handling system associated with the server object.

18. The method of claim 11 wherein executing the task lists with the server objects by deploying the tool box objects further comprises pulling the tool to the server information handling system associated with the server object.

19. The method of claim 11 further comprising scheduling one or more task lists for execution at predetermined times.

20. The method of claim 11 wherein extending the directory service schema with a policy object further comprises copying an existing policy object from a first sever object for use in a second server object.
